(19) United States
(12) Patent Application Publication
(10) Pub. No.: US 2010/0197263 A1
(43) Pub. Date: Aug. 5, 2010

(54) METHOD AND APPARATUS FOR COMBINED MULTI-CARRIER RECEPTION AND RECEIVE ANTENNA DIVERSITY

(75) Inventors: JOHANNA LISA DWYER, KANATA (CA); SHIROOK M. ALI, WATERLOO (CA); DANIEL NOEL BADIERE, KANATA (CA)

Correspondence Address: Smart & Biggar, P.O.Box 2999, Station D, 900-55 Metcalfe Street, Ottawa, ON, K1P 5Y6, CA

(73) Assignee: RESEARCH IN MOTION LIMITED, WATERLOO (CA)

(21) Appl. No.: 12/362,904

(22) Filed: Jan. 30, 2009

(51) Int. Cl. H04B 7/08

(52) U.S. Cl. 455/272

(57) ABSTRACT

Methods and wireless devices are provided that implement both multi-carrier reception and diversity processing.

### FIELD

The application relates to multi-carrier reception.

### BRIEF DESCRIPTION OF THE DRAWINGS

Embodiments of the application will now be described with reference to the attached drawings in which:

FIG. 1 is a block diagram of a first receiver that implements combined multi-carrier reception and receive antenna diversity;

FIGS. 2 through 6 are block diagrams of further receivers that implement combined multi-carrier reception and receive antenna diversity;

FIG. 7 is a flowchart of a method of performing multi-carrier reception and receive antenna diversity processing; and

FIG. 8 is a block diagram of a wireless device within which any of the methods described herein can be implemented.

### DETAILED DESCRIPTION

Multi-carrier techniques are able to significantly increase the peak throughput to a mobile device when the channel bandwidth is small, for example as is the case in many TDMA (time division multiple access) techniques. In a particular example of a multi-carrier technique, timeslots are assigned to a mobile device on each of the frequency carriers. In a particular example of such a multi-carrier approach, 3GPP has standardized a feature for Evolved EDGE called Downlink Dual Carrier (DLDC). On overview of this feature can be found in 3GPP TS 43.064 section 3.3.4. This feature allows two radio frequency carriers to be assigned to a mobile station. Timeslots are assigned on each of the frequency carriers, and in this way the number of timeslots that can be allocated to a mobile station can be increased. DLDC requires the receipt of two carriers at different frequencies and may require two realizations of the receiver circuitry that can be independently tuned to each of the carrier frequencies. Certain architectures of DLDC that only utilize one antenna may incur a sensitivity loss because of the splitting of the signal prior to the first active component.

Receive antenna diversity is another technique that can increase the throughput to a mobile device. With receive antenna diversity, a mobile device uses multiple antennas to receive the same transmitted signal, and performs diversity processing on multiple versions of the transmitted signal. The spatial diversity reception enabled by this architecture effectively improves the link channel quality. Depending on the environment that the signal is received in (e.g. AWGN, co-channel interference, mix of co-channel and adjacent channel interference . . . ) the gains can range from 3 dB to up to 10 dB or more. A specific implementation of receive antenna diversity is Mobile Station Receive Diversity (MSRD), which is also known as DARP Phase II (see 3GPP TS 45.005 Annex N). MSRD enables the mobile station to tolerate lower signal levels or a more hostile interference environment by using two antennas and applying diversity reception using the signals from the two antennas.

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

One broad aspect of the application provides a method in a wireless device comprising a first antenna and a second antenna, the method comprising:

processing an output of a first antenna at a first frequency to produce a first processed signal;

processing the output of the first antenna at a second frequency to produce a second processed signal;

processing an output of a second antenna at the first frequency to produced a third processed signal;

processing the output of the second antenna at the second frequency to produce a fourth processed signal;

performing diversity processing on the first processed signal and the third processed signal to produce a fifth signal; and

performing diversity processing on the second processed signal and the fourth processed signal to produce a sixth signal.

Another broad aspect of the application provides a wireless device comprising:

a first antenna;

a second antenna;

first receiver components configured to process an output of the first antenna at a first frequency to produce a first processed signal;

second receiver components configured to process the output of the first antenna at a second frequency to produce a second processed signal;

third receiver components configured to process an output of the second antenna at the first frequency to produced a third processed signal;

fourth receiver components configured to process an output of the second antenna at the second frequency to produce a fourth processed signal;

a diversity processor configured to perform diversity processing on the first processed signal and the third processed signal to produce a fifth signal and to perform diversity processing on the second processed signal and the fourth processed signal to produce a sixth signal.

Embodiments of the application provide systems and methods that combine multi-carrier reception and receive antenna diversity. In some embodiments, the multi-carrier reception approach is based on DLDC and the receive antenna diversity approach is based on MSRD. In some embodiments, the combination of features allows DLDC to be used in regions of high interference or poor signal quality. In some embodiments, this may also enable the use of a higher information rate MCS with DLDC. Advantageously, in some embodiments, by adding a diversity receiver branch for each of the two frequency channels in a DLDC architecture, the splitting loss that occurs in routing the signal from one antenna to two receivers may be recovered with the gains achieved from diversity reception.

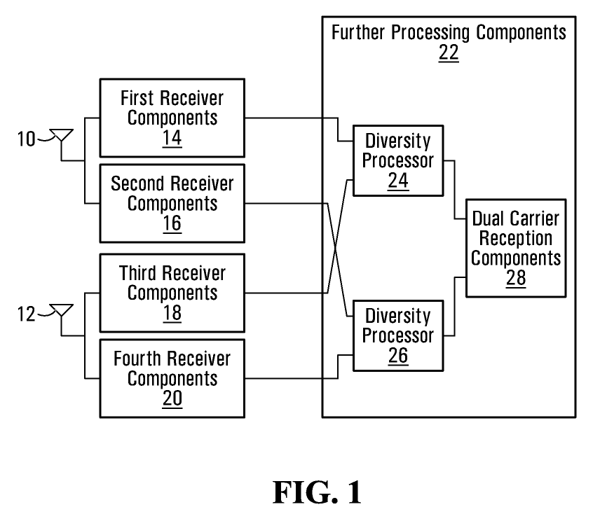

FIG. 1 is a block diagram of a receiver that implements combined multi-carrier reception and receive antenna diversity. The receiver might, for example, be implemented in a mobile station. The receiver has two antennas Antenna A 10, and Antenna B 12. Each antenna 10,12 is designed to work over a frequency range of f′→f″, which covers all applicable frequency bands supported by the mobile station. Antenna A 10 is connected to first receiver components 14 and second receiver components 16. A splitter (not shown) can be used to divide the signal received from the Antenna A 10. The first receiver components 14 has an output connected to further processing components 22. The second receiver components 16 has an output connected to the further processing components 22. Antenna B 12 is connected to third receiver components 18 and fourth receiver components 20. A splitter (not shown) can be used to divide the signal received from the Antenna B 12. The third receiver components 18 has an output connected to further processing components 22. The fourth receiver components 20 has an output connected to the further processing components 22. Additional components may be included. For example, there may be a filter at the input of each antenna 10,12. There may be an attenuator/isolator on each path leading to the receiver components 14,16,18,20. There may be a low noise amplifier that amplifies the received signal prior to splitting. Other components are possible. Additional components may include but are not limited to attenuators, filters, circulators, isolators, RF chokes, etc.

Factors that affect the correlation between the signals received by each antenna include the multi-path radio environment, the antenna design and physical separation, and the physical design of the radio and/or the physical design of other aspects of the mobile station itself. Factors that affect the signal strength that reaches each receiver front end include channel fading and user positioning (e.g. attenuation caused by hand or head position that affect each antenna differently).

The receiver components 14,16,18,20 are collectively configured to process two carriers received on each of the two antennas 10,12. In some embodiments, the two received carriers in the downlink direction have a frequency separation that is bound (for example, both carriers may be constrained to be in the same frequency band by specifications such as 3GPP TS 44.060).

In operation, the first receiver components 14 perform processing for the signal received over Antenna A 10 for a first carrier frequency. The second receiver components 16 perform processing for the signal received over Antenna A 10 for a second carrier frequency. The third receiver components 18 perform processing for the signal received over Antenna B 12 for the first carrier frequency. The fourth receiver components 20 perform processing for the signal received over Antenna B 12 for the second carrier frequency. Further processing components 22 receive two signals for the first frequency and two signals for the second frequency. The details of how these four signals are processed by the further processing components 22 are implementation specific. In the specific example illustrated, the two signals for the first frequency (i.e. the outputs of blocks 14,18) are processed in a first diversity processor 24, and the two signals for the second frequency (i.e. the outputs of blocks 16,20) are processed in a second diversity processor 26. The outputs of the diversity processors 24,26 are then processed, for example using dual carrier reception components 28.

### Further Processing

All of the embodiments described herein include some form of further processing of the multiple outputs produced for each frequency and each antenna. In all of these embodiments, this further processing includes diversity processing. In some embodiments, the further processing includes multi-carrier reception processing.

### Diversity Processing

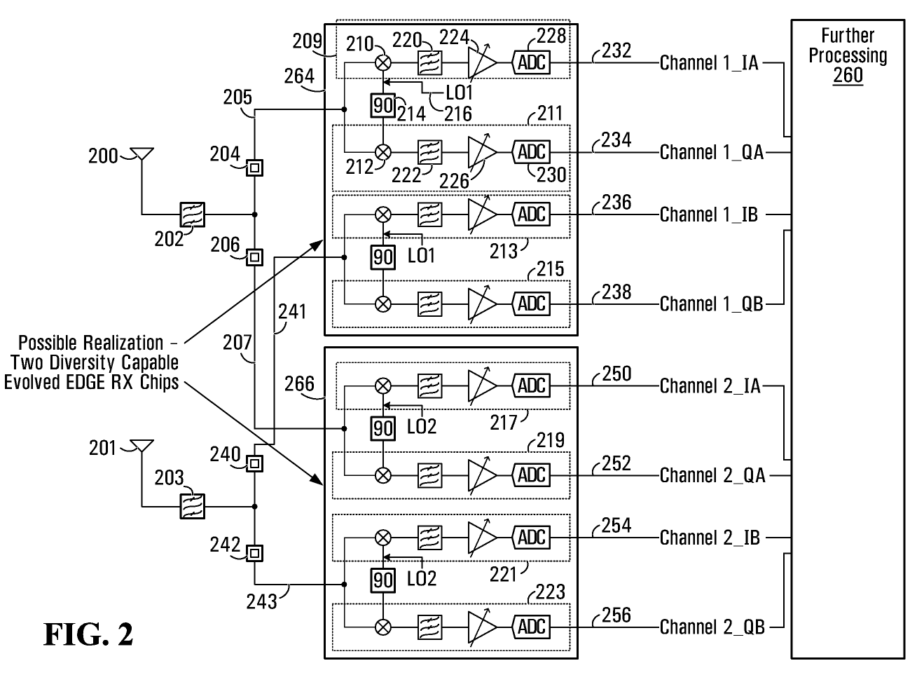

All of the embodiments described herein include some form of diversity processing to process multiple copies of signals received over a given carrier frequency and different antennas. This diversity processing may involve combining the two signals, or selecting between the two signals, or performing combining in some circumstances and selecting in other circumstances. This discussion relates not only to the diversity processing for the embodiment of FIG. 1, but also to the diversity processing for the embodiments of FIGS. 2 to 6.

In a specific example, the diversity processors 24,26 implement MSRD voting but other methods of diversity processing may alternatively be employed. In short, an MSRD voter looks at factors to determine whether or not to use diversity combination of the received signals from the two antennas. It may consider things such as factors available prior to demodulation of the signals, such as gain imbalance, or may consider factors available after the demodulation of the signal (such as correlation). It also may demodulate the signals using the receive branches individually as well as the diversity receiver and then compare the outcome to determine which outcome (from an individual branch or combination of branches) should be further processed in the receiver. The idea behind the voter is that it may not always be the best decision to combine the signals—in some cases the output of one or the other single branch is better.

In some embodiments, the diversity processors 24,26 take into account the relative signal strengths and correlations, and either combine the signals or not depending on the signal strengths and correlations. More specifically, there are cases where using a diversity receiver demodulator to combine information for a given carrier frequency from both receive antennas has benefits over using a legacy receiver demodulator on an individual receive chain. When the signals received do not suffer from a large gain imbalance and the two antennas are not strongly correlated, the diversity receiver demodulator will offer better performance than a legacy receiver demodulator. However if the signals are highly correlated, if there is a large gain imbalance, or if one of the receive paths has very low signal strength, then a legacy receiver demodulator used on the receive path with the strongest signal may outperform the diversity receiver demodulator. In some embodiments, the diversity processors 24,26 select between combining the information from the two antennas, or using only the signal from the receive path with the strongest signal (selection diversity).

The factors that affect the best selection can change on a frame by frame basis. In some embodiments, an MSRD voting mechanism is employed to make the decision as to whether the baseband processor should employ diversity demodulation to combine the two incoming signal branches or whether legacy demodulation would be favorable. This technique is described in detail in a commonly assigned co-pending U.S. application published on Aug. 7, 2008 having Publication Number US 2008/0188183, entitled “Method and Apparatus for Diversity Capable Receiver Selection using Voting”, hereby incorporated by reference in its entirety.

### Multi-Carrier Processing

As indicated above, in some embodiments, the further processing includes performing multi-carrier reception processing for at least two carrier frequencies f₁ and f₂. Note that the actual frequencies f₁ and f₂ may be dynamically assigned to a mobile station, or fixed. In a specific example, this involves receiving an assignment of timeslots on each of the carrier frequencies, and then performing further processing on the timeslots allocated to the mobile device on one or both of the assigned carriers.

Returning now to the example of FIG. 1, the functional blocks 14,16,18,20,24,26 are to be considered logical in nature. For example first receiver components 14 include any functionality implemented to extract the component of the signal received from the first antenna at the first carrier frequency. There may be one or more physical components that make up the first receiver components. The various receiver components 14,16,18,20 may be implemented using one or more physical components. For example, in some embodiments, some or all of the components for the first and third receiver components 14,18 are on a common integrated circuit (IC) or ICs, and some or all of the components for the second and fourth receiver components 16,20 are on a common IC or ICs. In another example, some or all of the components for the first and second receiver components 14,16 are on a common IC or ICs, and some or all of the components of the third and fourth receiver components 18,20 are on a common IC or ICs. In some embodiments, one or more of the receiver components include a component that is common to one or more of the other receiver components. Diversity processors 24,26 are functional elements that perform diversity processing. They may be combined in a single physical element or implemented separately.

Five specific examples of the receiver of FIG. 1 will now be described. A common element in all proposed methods and apparatus is the description and functionality of two antennas referred to as “Antenna A” and “Antenna B”. Both antennas are designed to have good performance in the frequency band f′→f″, where the two carrier frequencies f₁ and f₂ are within the frequency band f′→f″. In other words, f′<f₁<f₂<f″.

### Detailed Example—Zero IF Receiver Architecture, No LNA

FIG. 2 is a block diagram of a receiver that implements combined multi-carrier reception and receive antenna diversity that features a zero IF Receiver architecture, and does not incorporate an LNA (Low noise amplifier) prior to the splitting the received signal. Zero IF refers to a receiver architecture where the center frequency of a desired frequency band is translated directly to 0 Hz in one step. The receiver might, for example, be implemented in a mobile station. In some embodiments, the receiver of FIG. 2 is used to implement a combined MSRD and DLDC receiver. The receiver has two antennas Antenna A 200, and Antenna B 201 (typically identical and designed to support one or more RF frequency bands). Each antenna 200,201 is designed to work over a frequency range of f′→f″, which covers all applicable frequency bands supported by the mobile station.

As noted above, zero IF refers to a receiver architecture where the center frequency of a desired frequency band is translated directly to 0 Hz in one step.

It is noted that FIG. 2 shows a specific example of a zero IF (ZIF) receiver architecture. Other zero IF architectures may alternatively be employed. In another embodiment, a VLIF architecture is employed. In some embodiments, the arrangement of FIG. 2 is used to represent VLIF architecture with no additional components as the difference between ZIF and VLIF is not apparent from a block diagram. Other VLIF architectures may alternatively be employed. Very Low IF is a term that refers to a receiver architecture where there is only one IF and it is within a channel bandwidth of DC.

In another embodiment, a low IF architecture is employed. FIG. 2 is a specific example that can also be used to represent a low IF architecture if the down conversion from IF to baseband is done in the further processing block. Other low IF architectures may alternatively be employed. If the final down conversion occurs in the analog domain instead, then a second mixing stage (this one complex) along with low pass filters is needed before the ADC. Low IF refers to a receiver architecture with a single analog mixing stage that brings the desired channel down to a relatively low intermediate frequency (IF), but not 0 Hz.

The placements of some of the amplifiers and filters in the embodiment of FIG. 2, and the other embodiments described herein are flexible. For example in FIG. 2, amplifier 224 could be followed by another filter and even another amplifier.

Antenna A is connected to a bandpass filter 202. The output of bandpass filter 202 is split (for example using a passive splitter, not shown) in two and the two outputs are connected to respective isolator/attenuators 204,206 (which may or may not be present) having respective outputs 205,207. Output 205 is connected to f₁ I-channel processing 209 and f₁ Q-channel processing 211. An output 232 of f₁ I-channel processing 209 is connected to further processing block 260. An output 234 of f₁ Q-channel processing 211 is connected to further processing block 260. The output 207 is connected to f₂ I-channel processing 217 and f₂ Q-channel processing 219. An output 250 of f₂ I-channel processing 217 is connected to further processing block 260. An output 252 of f₂ Q-channel processing 219 is connected to further processing block 260.

Antenna B 201 is connected to a bandpass filter 203. The output of bandpass filter 203 is split (for example, using a passive splitter, not shown) in two and the two outputs are connected to respective isolator/attenuators 240,242 (which may or may not be present) having respective outputs 241,243. Output 241 is connected to f₁ I-channel processing 213 and f₁ Q-channel processing 215. An output 236 of f₁ I-channel processing 213 is connected to further processing block 260. An output 238 of f₁ Q-channel processing 215 is connected to further processing block 260. The output 243 is connected to f₂ I-channel processing 221 and f₂ Q-channel processing 223. An output 254 of f₂ I-channel processing 221 is connected to further processing block 260. An output 256 of f₂ Q-channel processing 223 is connected to further processing block 260.

Each of bandpass filter 202 and bandpass filter 203 may for example be implemented as a respective bank of bandpass filters in combination with a band select switch that is used to determine which bandpass filter the signal should pass through. The set of specific bands supported is an implementation specific detail. Some examples of currently deployed bands include 800 MHz, 900 MHz, 1800 MHz, 1900 MHz. One or more of these bands may be supported. Alternatively, completely different bands may be supported. Alternatively, one or more of the currently deployed bands in combination with one or more different bands may be supported.

In all of the embodiments described herein, where lowpass or bandpass filtering is employed (either following the antenna, or elsewhere in the receiver), more generally, some type of filtering may be employed as appropriate to a given implementation. The particular lowpass or bandpass filters by way of example only.

In some embodiments, the two carriers are limited to be within one of these bands. In other embodiments, the two carriers are not limited to be within one of these bands in which case the signal from each of the antennas may include a carrier on more than one of these bands, and both need to be passed by the filter. In some embodiments, where the carriers are permitted to be in more than one band, then the bandpass filter band may be replaced with a single wider band bandpass filter (i.e. with a passband spanning the lowest supported frequency (for example in the 800 MHz band) to the highest supported frequency (for example in the 1900 MHz band). In some embodiments, a low pass filter (not shown) is employed instead of a bandpass filter. f₁ I-channel processing 209 will be described by way of example. f₁ I-channel processing 209 comprises a mixer 210 connected to receive an output 216 of a local oscillator tuned to oscillator frequency LO1 corresponding with frequency f₁. Following the mixer 210 is a lowpass filter (LPF) 220, VGA (variable gain amplifier) 224 and ADC 228 the output of which is output 232. In the illustrated example, f₁ I-channel processing 213 is identical to f₁ I-channel processing 209.

f₁ Q-channel processing 211 will be described by way of example. f₁ Q-channel processing 211 comprises a mixer 212 connected to receive the output 216 of the local oscillator tuned to oscillator frequency LO1 corresponding with frequency f₁ after a 90 degree phase shift 214. Following the mixer 212 is a lowpass filter 222, VGA 226 and ADC 230 the output of which is output 234. In the illustrated example, f₁ Q-channel processing 215 is identical to f₁ I-channel processing 211.

f₁ channel processing 209,211,213,215 will collectively be referred to as f₁ channel processing 264, and f₂ channel processing 217,219,221,223 will collectively be referred to as f₂ channel processing 266. f₂ channel processing 266 is identical to f₁ channel processing 264 with the exception of the use of a local oscillator tuned to oscillator frequency LO2 corresponding with frequency f₂ in place of the local oscillator tuned to oscillator frequency LO1 corresponding with frequency f₁.

In some embodiments, f₁ channel processing 264 is implemented as a first RF chipset, and f₂ channel processing 266 is implemented as a second RF chipset. The chipsets may for example employ a homodyne (zero IF or ZIF) architecture, or a low IF architecture or a very low IF architecture. In operation, the two assigned frequency carriers, f₁ and f₂, are contained in the range of the two antennas 200,201 and are received by both antennas. Signals on each of outputs 205,207,241,243 therefore each contain instances of the signal components at f₁ and f₂. f₁ I-channel processing 209 processes the I-channel of the f₁ component of the signal received over Antenna A 200 to produce Channel 1_IA at output 232. f₁ Q-channel processing 211 processes the Q-channel the f₁ component of the signal received over Antenna A 200 to produce Channel 1_QA at output 234. f₁ I-channel processing 213 processes the I-channel of the f₁ component of the signal received over Antenna B 201 to produce Channel 1_IB at output 236. f₁ I-channel processing 215 processes the Q-channel the f₁ component of the signal received over Antenna B 201 to produce Channel 1_QB at output 238.

f₂ I-channel processing 217 processes the I-channel of the f₂ component of the signal received over Antenna A 200 to produce Channel 2_IA at output 250. f₂ Q-channel processing 219processes the Q-channel the f₂ component of the signal received over Antenna A 200 to produce Channel 2_QA at output 252. f₂ I-channel processing 221 processes the I-channel of the f₂ component of the signal received over Antenna B 201 to produce Channel 2_IB at output 254. f₂ I-channel processing 223 processes the Q-channel the f₂ component of the signal received over Antenna B 201 to produce Channel 2_QB at output 256.

The detailed discussion of further processing provided above in reference to FIG. 1 applies here as well.

### Detailed Example—Zero IF Architecture, LNA

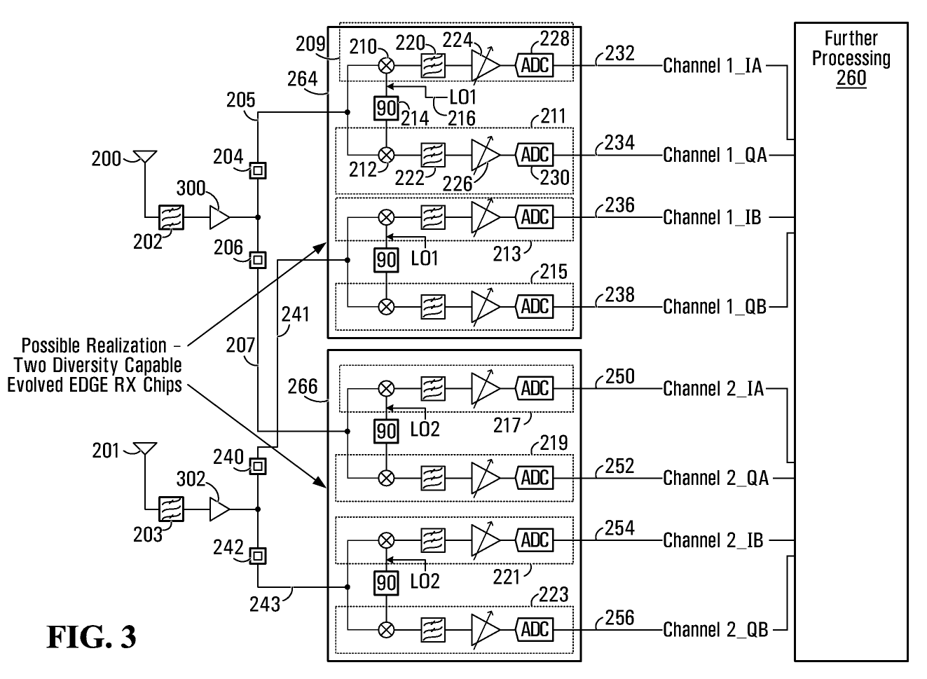

FIG. 3 is a block diagram of a receiver that implements combined multi-carrier reception and receive antenna diversity that features zero IF architecture, and does incorporate an LNA (Low noise amplifier) prior to splitting the input signal. The receiver might, for example, be implemented in a mobile station. In some embodiments, the receiver of FIG. 3 is used to implement a combined MSRD and DLDC receiver. Specifically, the apparatus of FIG. 3 is identical to the apparatus of FIG. 2 except for the presence of LNA 300 following bandpass filter 202, and the presence of LNA 302 following bandpass filter 203. In operation, the received signals are amplified by the low noise amplifiers 300,302 prior to being split. This pre-amplification may be used to restore the RF sensitivity to the signals which may be lost due to the passive loss of the splitting element prior to any active component in the receive chain. Corresponding embodiments for low IF and very low IF architectures are also provided.

### Detailed Example—Superheterodyne Architecture

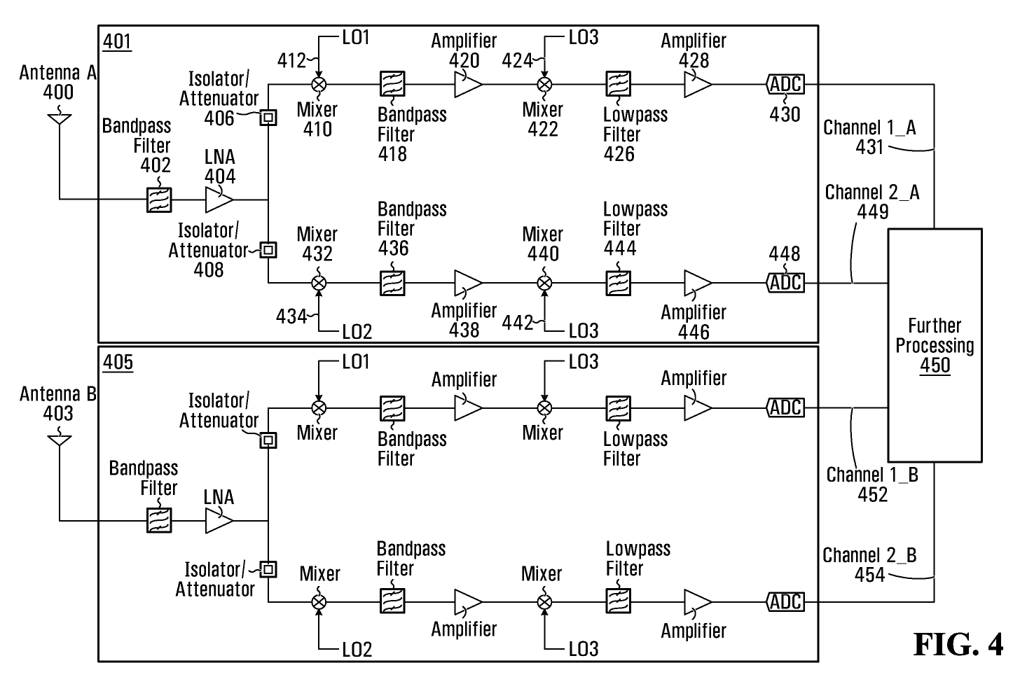

FIG. 4 is a block diagram of a receiver that implements combined multi-carrier reception and receive antenna diversity that features a superheterodyne architecture, where the previous two examples were Zero or Low IF receivers. The receiver might, for example, be implemented in a mobile station. In some embodiments, the receiver of FIG. 4 is used to implement a combined MSRD and DLDC receiver. This is just one example of a superheterodyne receiver architecture that might be employed; generally, a superheterodyne receiver architecture features multiple mixing stages (two are shown here) and a common IF frequency. Note that for the example of FIG. 4, I and Q channels are not shown. However, such channels would be typically implemented digitally in the “Further Processing” block in the event quadrature modulation is employed.

The receiver has two antennas Antenna A 400, and Antenna B 403. Antenna A processing 401 contains components that process the signal received over Antenna A 400, and Antenna B processing 405 contains components that process the signal received over Antenna B 403. Antenna A processing 401 is substantially identical to Antenna B processing 405 and as such only Antenna A processing 401 will be described in detail. Antenna A processing 401 includes a bandpass filter 402, LNA 404, splitter (not shown) connecting the output of the LNA to a first mixer 410 and a second mixer 432 via the isolator/attenuator which may or may not be present. The first mixer 410 is connected to a local oscillator 412 tuned to oscillate at LO1. The mixer 410 is followed by a bandpass filter 418, amplifier 420, and mixer 422 connected to a local oscillator 424 tuned to oscillate at LO3. Mixer 422 is followed by lowpass filter 426, amplifier 428 and ADC 430 which produces output 431 that is connected to further processing 450. The second mixer 432 is connected to a local oscillator 434 oscillating at LO2. The mixer 432 is followed by a bandpass filter 436, amplifier 438, and mixer 440 connected to a local oscillator 442 tuned to oscillate at LO3. Mixer 440 is followed by lowpass filter 444, amplifier 446 and ADC 448 which produces output 449 that is connected to further processing 450. Similarly, Antenna B processing 405 has outputs 452,454 connected to further processing 450.

In this architecture, LO1 and LO2 are selected such that the input frequencies f₁ and f₂ are both translated down to an identical IF frequency. These two signals at IF are then subsequently translated to baseband with a second mixing stage using a common LO frequency at LO3. This produces two signals Channel 1_A, Channel 2_A coming into further processing 450 from Antenna A processing 401 representing the signals transmitted on f₁ and f₂, and two more signals Channel 1_B, Channel 2_B coming into further processing 450 from Antenna B processing 405 also representing the signals transmitted on f₁ and f₂. The further processing 450 then uses Channel 1_A and Channel 1_B copies of the signal from f₁ for diversity processing and uses the Channel 2_A and Channel 2_B copies of the signal from f₂ for diversity processing.

The detailed discussion of further processing provided above in reference to FIG. 1 applies here as well.

### Detailed Example—Image Rejection Architecture

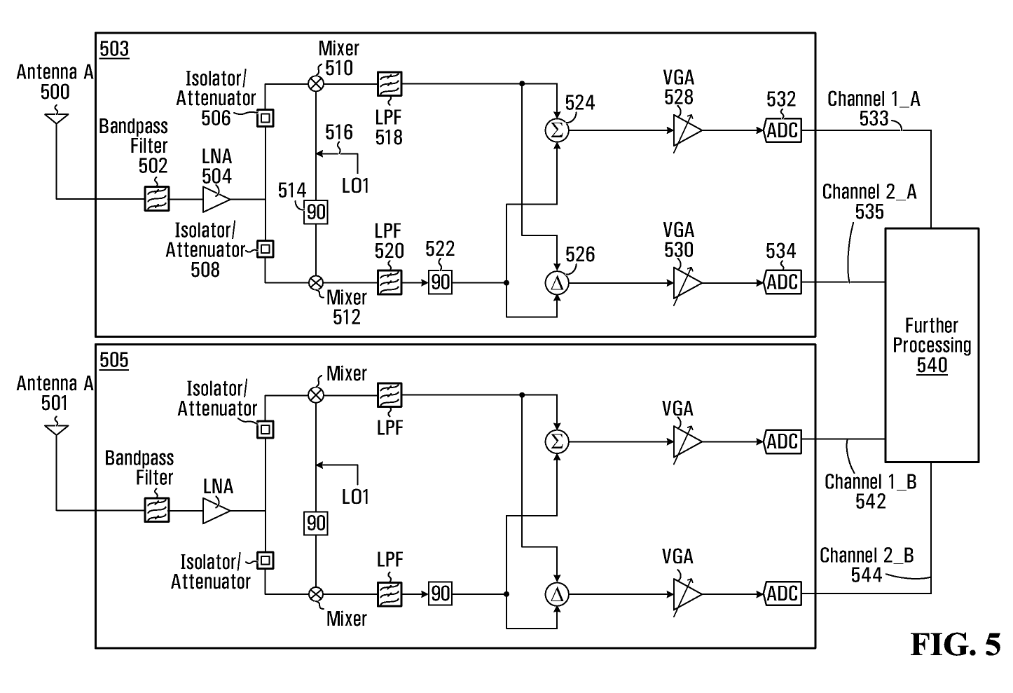

FIG. 5 is a block diagram of a receiver that implements combined multi-carrier reception and receive antenna diversity that is based on an image rejection architecture. The receiver might, for example, be implemented in a mobile station. In some embodiments, the receiver of FIG. 5 is used to implement a combined MSRD and DLDC receiver. This is just one example of an image rejection receiver architecture that might be employed. Note that for the example of FIG. 5, I and Q channels are not shown. However, such channels would be typically be implemented digitally in the “Further Processing” block in the event quadrature modulation is employed.

The receiver has two antennas Antenna A 500, and Antenna B 501. Antenna A processing 503 contains components that process the signal received over Antenna A 500, and Antenna B processing 505 contains components that process the signal received over Antenna B 501. Antenna A processing 503 is substantially identical to Antenna B processing 505 and as such only Antenna A processing 503 will be described in detail.

Antenna A processing 503 includes a bandpass filter 502, LNA 504, splitter (not shown) connecting the output of the LNA to a first mixer 510 and a second mixer 512 via respective isolator/attenuators 506,508 which may or may not be present. The first mixer 510 is connected to a local oscillator 516 tuned to oscillate at LO1. The mixer 510 is followed by a lowpass filter 518 the output of which is connected to a first input of a summer 524, which in turn is followed by VGA 528 and ADC 532 which produces output 533 that is connected to further processing 540. The output of the lowpass filter 518 is also connected to a first input of a differencer 526, which in turn is followed by VGA 530, ADC 534 which produces output 535 that is connected to further processing 540. The second mixer 512 is also connected to a local oscillator 516 oscillating at LO1 but through 90 degree phase shifter 514. The mixer 512 is followed by a lowpass filter 520 the output of which is connected through a 90 degree phase shifter 522 to a second input of the summer and to a second input of the differencer 526.

Similarly, Antenna B processing 505 has outputs 542,544 connected to further processing 540.

This apparatus eliminates the requirement for the two or more LOs used in the superheterodyne architecture by tuning LO1 to a frequency that is the average of f₁ and f₂. Note the output of the lowpass filters (e.g. filters 518,520) contains content for both carriers. In some implementations, f1 and f2 are constrained to be in the same frequency band, and therefore the maximum frequency separation of the two carriers can be bounded (for example in GSM the widest frequency band is the DCS band which is 75 MHz wide). If the bandwidth of the GSM band is BW and assuming that f₁>f₂, then this mixing function will translate the two frequency carriers to:

f₁′=f₁−f_{LO} and f₂′=f₂−f_{LO}

where

$${f}_{LO} = \frac{{f}_{1} + {f}_{2}}{2}$$

Thus the two carriers will be translated to an IF frequency that is less than or equal to BW/2. Note f₁′ will be a positive frequency and f₂′ will be a negative frequency. These signals are passed through a low pass filter. These signals maybe at relatively high frequencies but their bandwidths are small, therefore they can be quantized appropriately with, for example, a bandpass ΣΔ converter typically forming part of the ADC components. The band-reject noise-shaping of a bandpass ΣΔ converter results in high signal-to-noise ratios for narrow-band signals.

This produces two signals Channel 1_A, Channel 1_B coming into further processing 540 from Antenna A processing 503 representing the signals transmitted on f₁ and f₂, and two more signals Channel 1_B, Channel 2_B coming into further processing 540 from Antenna B processing 505 also representing the signals transmitted on f₁ and f₂. The further processing 540 then uses Channel 1_A and Channel 1_B copies of the signal from f₁ for diversity processing and uses the Channel 2_A and Channel 2_B copies of the signal from f₂ for diversity processing. The detailed discussion of further processing provided above in reference to FIG. 1 applies here as well.

Detailed Example—Image Rejection Architecture with IF Mixing Stage

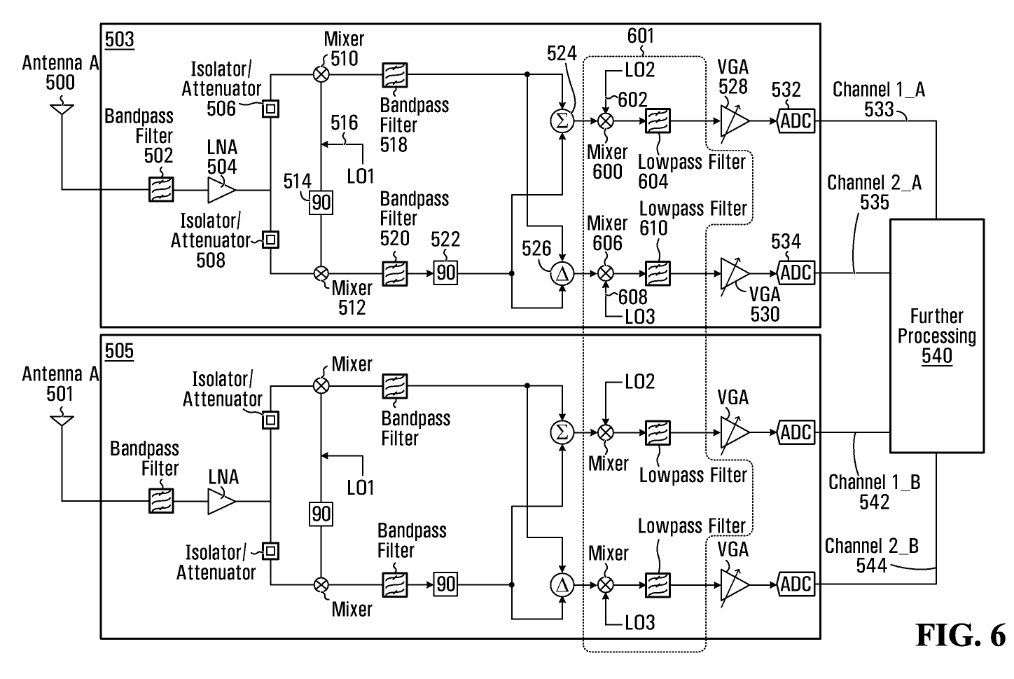

FIG. 6 is a block diagram of a receiver that implements combined multi-carrier reception and receive antenna diversity that is based on an image rejection architecture with an IF mixing stage. The receiver might, for example, be implemented in a mobile station. In some embodiments, the receiver of FIG. 6 is used to implement a combined MSRD and DLDC receiver. This is just one example of an image rejection receiver architecture that might be employed. Note that for the example of FIG. 6, I and Q channels are not shown. However, such channels would be implemented in the event quadrature modulation is employed either in the analog domain prior to the ADC or in the digital domain in the further processing block.

The embodiment of FIG. 6 is identical to the embodiment of FIG. 5 with the exception of an IF mixing stage 601 that follows the summer and differencer elements in each of Antenna A and B processing 503,505. For example, summer 524 is followed by a mixer 600 connected to an oscillator 602 that is tuned to oscillate at LO2. The mixer is followed by a lowpass filter 604. Similarly, differencer 526 is followed by a mixer 606 connected to an oscillator 608 that is tuned to oscillate at LO3. The mixer is followed by a lowpass filter 610. In this architecture the entire received signal is mixed down to an IF frequency as in the example of FIG. 5. After this point, two different LO frequencies LO2 and LO3 are used to extract the two carrier frequencies. These signals are then fed into the further processing 540.

The detailed discussion of further processing provided above in reference to FIG. 1 applies here as well.

### Method

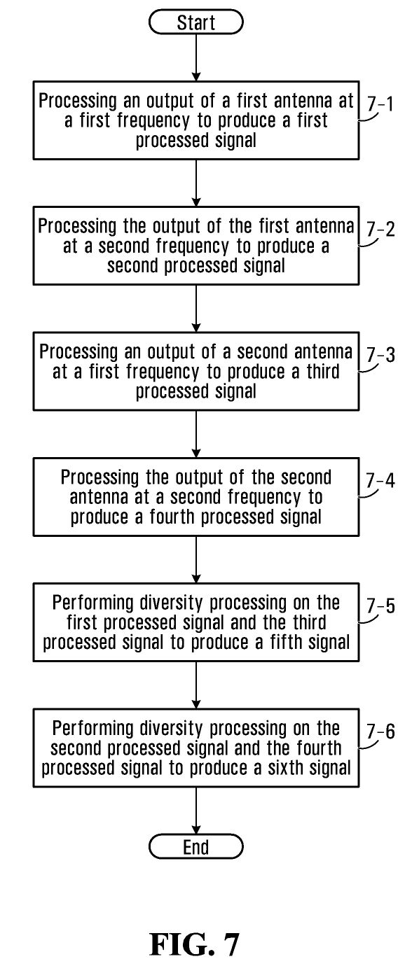

FIG. 7 is a flowchart of a method of performing combined multi-carrier and receive antenna diversity reception. The method is performed by a mobile device having a first antenna and a second antenna. The method begins in block 7-1 with processing an output of a first antenna at a first frequency to produce a first processed signal. The method continues in block 7-2 with processing the output of the first antenna at a second frequency to produce a second processed signal. The method continues in block 7-3 with processing an output of a second antenna at a first frequency to produced a third processed signal. The method continues in block 7-4 with processing the output of the second antenna at a second frequency to produce a fourth processed signal. The method continues in block 7-5 with performing diversity processing on the first processed signal and the third processed signal to produce a fifth signal. Diversity processing may involve a selection of one of the first and third signals to be the fifth signal, or it may involve combining the two signals to create the fifth signal, as described previously, or it may involve selectively performing one of these two approaches. The method continues in block 7-6 with performing diversity processing on the second processed signal and the fourth processed signal to produce a sixth signal. Diversity processing may involve a selection of one of the second and fourth signals to be the sixth signal, or it may involve combining the two signals to create the sixth signal, as described previously, or it may involve selectively performing one of these two approaches. In some embodiments, block 7-6 is followed by a further block in which processing the fifth and sixth signals using dual carrier reception techniques is performed. The blocks may involve any of the specific examples of receive signal processing given above, such as zero IF with/without LNA, superheterodyne, image rejection with/without extra mixing stage, although not limited to the specific examples of these approaches given herein. Other methods that have been developed, or are yet to be developed, not described herein may alternatively be employed.

### Wireless Device

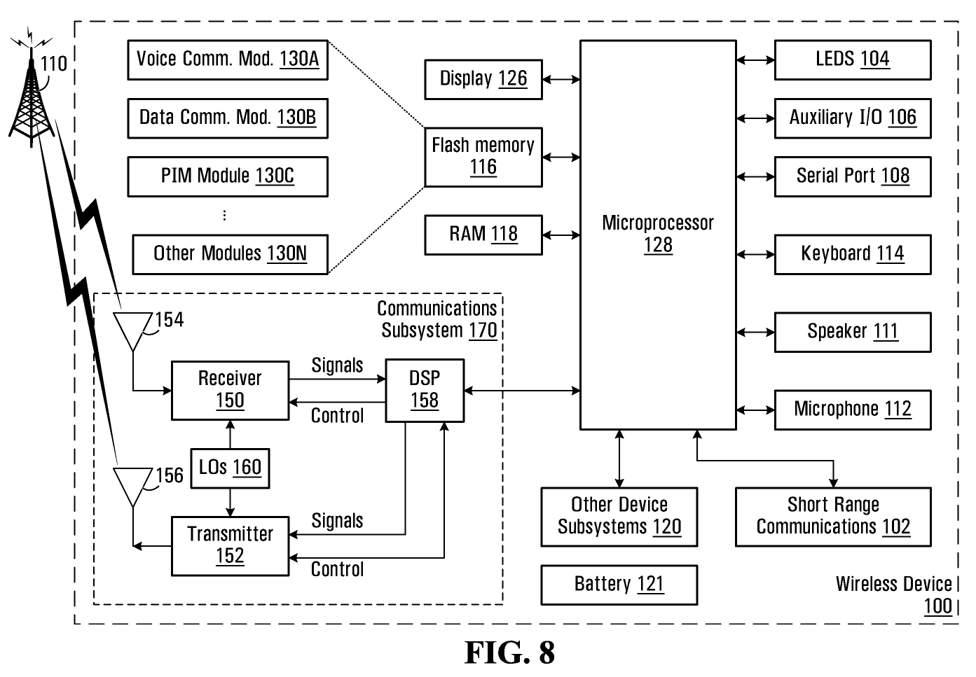

Referring now to FIG. 8, shown is a block diagram of a wireless device 100 that may, for example, implement any of the mobile device methods described in this disclosure. It is to be understood that the wireless device 100 is shown with very specific details for exemplary purposes only. A processing device (a microprocessor 128) is shown schematically as coupled between a keyboard 114 and a display 126. The microprocessor 128 controls operation of the display 126, as well as overall operation of the wireless device 100, in response to actuation of keys on the keyboard 114 by a user.

The wireless device 100 has a housing that may be elongated vertically, or may take on other sizes and shapes (including clamshell housing structures). The keyboard 114 may include a mode selection key, or other hardware or software for switching between text entry and telephony entry.

In addition to the microprocessor 128, other parts of the wireless device 100 are shown schematically. These include: a communications subsystem 170; a short-range communications subsystem 102; the keyboard 114 and the display 126, along with other input/output devices including a set of LEDs 104, a set of auxiliary I/O devices 106, a serial port 108, a speaker 111 and a microphone 112; as well as memory devices including a flash memory 116 and a Random Access Memory (RAM) 118; and various other device subsystems 120. The wireless device 100 may have a battery 121 to power the active elements of the wireless device 100. The wireless device 100 is in some embodiments a two-way radio frequency (RF) communication device having voice and data communication capabilities. In addition, the wireless device 100 in some embodiments has the capability to communicate with other computer systems via the Internet.

Operating system software executed by the microprocessor 128 is in some embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the wireless device 100 may also be stored to the RAM 118.

The microprocessor 128, in addition to its operating system functions, enables execution of software applications on the wireless device 100. A predetermined set of software applications that control basic device operations, such as a voice communications module 130A and a data communications module 130B, may be installed on the wireless device 100 during manufacture. In addition, a personal information manager (PIM) application module 130C may also be installed on the wireless device 100 during manufacture. The PIM application is in some embodiments capable of organizing and managing data items, such as e-mail, calendar events, voice mails, appointments, and task items. The PIM application is also in some embodiments capable of sending and receiving data items via a wireless network 110. In some embodiments, the data items managed by the PIM application are seamlessly integrated, synchronized and updated via the wireless network 110 with the device user's corresponding data items stored or associated with a host computer system. As well, additional software modules, illustrated as another software module 130N, may be installed during manufacture.

Communication functions, including data and voice communications, are performed through the communication subsystem 170, and possibly through the short-range communications subsystem 102. The communication subsystem 170 includes a receiver 150, a transmitter 152 and one or more antennas, illustrated as a receive antenna 154 and a transmit antenna 156. In addition, the communication subsystem 170 also includes a processing module, such as a digital signal processor (DSP) 158, and local oscillators (LOs) 160. The communication subsystem 170 having the transmitter 152 and the receiver 150 includes functionality for implementing one or more of the embodiments described above in detail. The specific design and implementation of the communication subsystem 170 is dependent upon the communication network in which the wireless device 100 is intended to operate. For example, the communication subsystem 170 of the wireless device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Examples of CDMA include 1× and 1× EV-DO. The communication subsystem 170 may also be designed to operate with an 802.11 Wi-Fi network, and/or an 802.16 WiMAX network. Other types of data and voice networks, both separate and integrated, may also be utilized with the wireless device 100.

Network access may vary depending upon the type of communication system. For example, in the Mobitex™ and DataTAC™ networks, wireless devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the wireless device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150 and the transmitter 152. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using the keyboard 114 and/or some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the wireless device 100. In addition, the display 126 may also be utilized in voice communication mode, for example, to display the identity of a calling party, the duration of a voice call, or other voice call related information.

The short-range communications subsystem 102 enables communication between the wireless device 100 and other proximate systems or devices, which need not necessarily be similar devices. For example, the short range communications subsystem may include an infrared device and associated circuits and components, or a Bluetooth™ communication module to provide for communication with similarly-enabled systems and devices.

In some implementations, the wireless device 100 is capable of operating in multiple modes such that it can engage in both CS (Circuit-Switched) as well as PS (Packet-Switched) communications, and can transition from one mode of communications to another mode of communications without loss of continuity. Other implementations are possible.

Numerous modifications and variations of the present application are possible in light of the above teachings. It is therefore to be understood that within the scope of the appended claims, embodiments may be practiced otherwise than as specifically described herein.

For example, the embodiments of FIGS. 2 and 3 could be realized with a low IF or VLIF (Very Low IF) architecture instead of the ZIF (Zero IF) architecture that is shown in the figures. For embodiments featuring a second mixing stage (i.e. there is an IF frequency in the RF architecture), in some embodiments, the signal is directly digitized at the output of the second mixing stage using a high speed A/D converter or a conventional or bandpass ΣΔ modulator with noise shaping properties.

While the embodiments described have referred to mobile devices, more generally, they are applicable to wireless devices which may or may not be mobile.

We claim:

1. A method in a wireless device comprising a first antenna and a second antenna, the method comprising:
processing an output of a first antenna at a first frequency to produce a first processed signal;
processing the output of the first antenna at a second frequency to produce a second processed signal;
processing an output of a second antenna at the first frequency to produced a third processed signal;
processing the output of the second antenna at the second frequency to produce a fourth processed signal;
performing diversity processing on the first processed signal and the third processed signal to produce a fifth signal; and
performing diversity processing on the second processed signal and the fourth processed signal to produce a sixth signal.

2. The method of claim 1 further comprising:
processing the fifth and sixth signals using dual carrier reception techniques.

3. The method of claim 1 wherein processing to produce the first, second, third and fourth signals comprises:
using a zero IF receiver architecture.

4. The method of claim 1 wherein processing to produce the first, second, third and fourth signals comprises:
using a low IF receiver architecture or a very low IF receiver architecture.

5. The method of claim 3 further comprising:
amplifying a signal received at the first antenna to produce a first amplified signal;
splitting the first amplified signal for processing to produce the first processed signal and the second processed signals;
amplifying a signal received at the second antenna to produce a second amplified signal;
splitting the second amplified signal for processing to produce the third and fourth processed signals.

6. The method of claim 1 wherein processing to produce the first, second, third and fourth signals comprises:
using a superheterodyne receiver architecture.

7. The method of claim 1 wherein processing to produce the first, second, third and fourth signals comprises:
using a receiver architecture with an image rejection architecture.

8. The method of claim 1 wherein processing to produce the first, second, third and fourth signals comprises:
using an image rejection receiver architecture with an IF Mixing stage.

9. The method of claim 1 further comprising:
receiving an assignment of timeslots on each of the frequencies;
performing further processing on the timeslots allocated to the wireless device.

10. The method of claim 9 wherein the receiving and performing steps are performed in accordance with DLDC (downlink dual carrier).

11. The method of claim 1 wherein performing diversity processing comprises using an MSRD (mobile station receive diversity) voting mechanism.

12. A wireless device comprising:
a first antenna;
a second antenna;
first receiver components configured to process an output of the first antenna at a first frequency to produce a first processed signal;
second receiver components configured to process the output of the first antenna at a second frequency to produce a second processed signal;
third receiver components configured to process an output of the second antenna at the first frequency to produced a third processed signal;
fourth receiver components configured to process an output of the second antenna at the second frequency to produce a fourth processed signal;
a diversity processor configured to perform diversity processing on the first processed signal and the third processed signal to produce a fifth signal and to perform diversity processing on the second processed signal and the fourth processed signal to produce a sixth signal.

13. The wireless device of claim 12 further comprising:
a dual carrier signal processing component configured to process the fifth and sixth signals using dual carrier reception techniques.

14. The wireless device of claim 12 wherein the first, second, third and fourth receiver components implement a receiver architecture with zero IF split.

15. The wireless device of claim 12 wherein the first, second, third and fourth receiver components comprise a low IF receiver architecture or a very low IF receiver architecture.

16. The wireless device of claim 14 further comprising:
a first low noise amplifier for the first antenna to produce a first amplified signal;
a splitter that splits the first amplified signal for processing by the first and second receiver components
a second low noise amplifier for the second antenna to produce a second amplified signal;
a splitter that splits the second amplified signal for processing by the third and fourth receiver components.

17. The wireless device of claim 12 wherein the first, second, third and fourth receiver components implement a superheterodyne architecture.

18. The wireless device of claim 12 wherein the first, second, third and fourth receiver components implement an image rejection architecture.

19. The wireless device of claim 12 wherein the first, second, third and fourth receiver components implement an image rejection architecture with an IF Mixing stage.

20. The wireless device of claim 12 wherein the dual carrier signal processing component is configure to:
receive an assignment of timeslots on each of the frequencies;
perform further processing on the timeslots allocated to the wireless device.

21. The wireless device of claim 20 wherein the receiving and performing are performed in accordance with DLDC (downlink dual carrier).

22. The wireless device of claim 12 the diversity processor using an MSRD (mobile station receive diversity) voting mechanism.
